(19) United States
(12) Patent Application Publication
(10) Pub. No.: US 2009/0045661 A1
(43) Pub. Date: Feb. 19, 2009

(54) DEVICE AND METHOD FOR SEAT COMPONENT ADJUSTMENT, AND SEAT

(76) Inventors: Veit Stoessel, Nuernberg (DE); Klaus Junker, Diessen am Ammersee (DE); Gunter Maierhofer, Stahnsdorf (DE)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/093,129

(22) PCT Filed: Nov. 27, 2006
(86) PCT No.: PCT/EP06/11364

§ 371 Date: Jun. 12, 2008

(30) Foreign Application Priority Data
Dec. 1, 2005 (DE) 10 2005 057 462.9

(51) Int. Cl. B60N 2/02; F16H 1/32; B60N 2/225; B60N 2/66; B60N 2/46

(52) U.S. Cl. 297/284.4; 74/63; 297/362; 297/410

(57) ABSTRACT

A seat-component adjusting device of a compact overall size and with a high transmission ratio comprises an electric motor (10), a worm gear (11, 12) coupled at the input side to the electric motor, an eccentric gear (13, 14) coupled at the input side to the worm gear, and a rotary element (17) coupled by coupling means (21, 22) to the eccentric gear (13, 14). The coupling means (21, 22) are designed to convert a wobbling movement of a rotor (13) of the eccentric gear into a rotational movement of the rotary element (17).

The present invention relates to a seat-component adjusting device, a seat having said device, and a method of adjusting a seat component. In particular, the present invention relates to a seat-component adjusting device, which is designed to adjust a cable control, as well as to a corresponding seat.

These days, many seats have an adjustable seat component or a number of adjustable seat components that is or are adjusted by electrical driving means. For example, such adjusting devices are used to adjust backrests, headrests, side panels etc. of a seat, wherein the adjustment is often effected by means of cable controls or Bowden cables. To improve seat comfort, the number of such adjustable seat components has increased. Along with the number of electric functions integrated in the seat, the number of adjusting devices needed for these seat components often also increases. However, as the total installation space available for the adjusting devices is limited, the increase of adjustable seat components leads to the need for adjusting devices of a compact overall size.

An object of the present invention is to provide an improved seat-component adjusting device. In particular, it is an object of the present invention to provide a seat-component adjusting device of a small overall size. A further object of the invention is to provide such a seat-component adjusting device, which simultaneously has a high transmission ratio.

A further object of the invention is to provide an improved seat having an adjustable seat component. In particular, it is an object to provide such a seat, which has a seat-component adjusting device of a small overall size.

Yet another object of the present invention is to provide an improved method of adjusting a seat component. In particular, it is an object to provide such a method, whereby the installation space required for a seat-component adjusting device is relatively small and/or the transmission ratio of the seat-component adjusting device is relatively high.

According to the invention, these objects are achieved by a seat-component adjusting device according to claim 1, a seat according to claim 13, and a method of adjusting a seat component according to claim 16. The dependent claims define advantageous or preferred embodiments of the invention.

A seat-component adjusting device according to the invention comprises rotary driving means, a worm gear, an eccentric gear and a rotary element for coupling to a pulling element, wherein the worm gear is coupled at the input side to the rotary driving means and at the output side to the eccentric gear, and wherein the eccentric gear is further coupled at the output side by coupling means to the rotary element, wherein the coupling means are designed to convert a movement of the eccentric gear into a rotational movement of the rotary element. The pulling element is coupled to the rotary element. By virtue of this design, a seat-component adjusting device of a compact overall size is realized, which may moreover have a high transmission ratio. The seat-component adjusting device according to the invention moreover enables self-locking.

In an embodiment, the pulling element is a flexible pulling element, so that an adjustment of the pulling element is possible by winding or unwinding the pulling element onto or from the rotary element.

In a preferred embodiment of the seat-component adjusting device, the worm gear comprises a worm coupled to the rotary driving means as well as a rotatably supported worm wheel, and the eccentric gear comprises a rotationally fixed ring gear with internal gearing as well as a rotor, which is disposed rotatably in the ring gear and in mesh with the ring gear. In said case, there is provided on the worm wheel an eccentric, which is designed to roll the rotor along the internal gearing of the ring gear. This design of the seat-component adjusting device, by virtue of its modular design, allows easy adaptation of the transmission ratio. In particular, a relatively high transmission ratio may be realized by suitably selecting the tooth numbers of the worm, the worm wheel, the ring gear and the rotor.

In the previously described embodiment, the worm gear preferably has a transmission ratio in the region of 15 to 25, and the eccentric gear has a transmission ratio in the region of 10 to 20. It is further preferred that the tooth number of the worm is 1 or 2, and the tooth number of the worm wheel assumes a value in the region of 15 to 50. It is further preferred that the tooth number of the rotor assumes a value in the region of 20 to 40. It is additionally further preferred that the tooth number of the internal gearing of the ring gear is higher by 1 to 3 than that of the rotor. By virtue of such a selection of tooth numbers, a high transmission ratio combined with a high engagement factor is realized.

The rotary driving means preferably comprise an electric motor. In this way, easy controllability of the seat-component adjusting means is achieved. Manual actuation is however also conceivable, in which case the rotary driving means may comprise a hand wheel or the like.

The coupling means preferably comprise first coupling elements provided on the eccentric gear as well as second coupling elements provided on the rotary element. In particular, the first coupling elements may comprise a plurality of pins and the second coupling elements a plurality of recesses, wherein the pins and the recesses are in paired engagement. The first coupling elements may alternatively comprise a plurality of recesses and the second coupling elements a plurality of pins, wherein the pins and the recesses are in paired engagement. Should the eccentric gear comprise a rotor and a ring gear, the first coupling elements may be provided on the rotor, wherein a diameter of a pin is selected smaller by the difference of the pitch diameters of the ring gear and the rotor than a diameter of a recess, with which the pin is in engagement. The recesses and the pins in said case each have a cylindrical outer periphery. The pins and the corresponding recesses are a realization of the coupling means by simple mechanical elements.

In an embodiment, the worm, the worm wheel, the rotor and the rotary element are disposed in a housing, thereby allowing the seat-component adjusting device to be installed as a module. A portion of the ring gear may moreover also form a portion of the housing, with the result that the design of the seat-component adjusting device becomes even more compact and/or the number of required components is reduced. Internal gearing may also be provided on a portion of the housing, so that a portion of the housing acts as the ring gear of the eccentric gear.

The flexible pulling element may in particular be a cable control or Bowden cable. One end of the wire or steel cable of the Bowden cable is then preferably coupled to the rotary element. Should the seat-component adjusting device comprise a housing, this housing may moreover be arranged such that a sheath of the Bowden cable may be secured on a portion of the housing.

The pulling element may alternatively be a gear rack, the gearing of which is in mesh with gearing provided on the rotary element. The gear rack may be designed for direct coupling to a seat component that is to be adjusted. Alternatively, the gear rack may be arranged for coupling to a flexible pulling element, e.g. a wire pull, which in turn while in use is coupled directly to the seat component that is to be adjusted.

A seat according to the invention includes an adjustable seat component as well as a seat-component adjusting device according to the invention, wherein the pulling element is coupled to the adjustable seat component for actuation thereof. The pulling element may be coupled directly or by one or more further connection elements to the adjustable seat component. Given a seat designed in this way, the seat-component adjusting device is of a small overall size and may therefore easily be accommodated on or in the seat.

The adjustable seat component may be any desired seat component, in particular a lumbar support or a headrest. In said case, the lumbar support may be designed and coupled to the seat-component adjusting device in such a way that a height adjustment and/or an adjustment of the curvature of the lumbar support is achieved by means of the seat-component adjusting device. Similarly, the headrest may be designed and coupled to the seat-component adjusting device in such a way that a height adjustment and/or an inclination adjustment of the headrest is achieved by means of the seat-component adjusting device. The adjustable seat component may then be designed in each case in such a way that it is adjusted in dependence upon a free length of the flexible pulling element, i.e. in dependence upon a degree of take-up of the flexible pulling element by the seat-component adjusting device. Because of the high transmission ratio that is achievable with the seat-component adjusting device according to the invention, a reliable adjustment of the adjustable seat component may then be achieved. Furthermore, the self-locking of the seat-component adjusting device prevents an intentional adjustment of the seat component under load.

A method according to the invention of adjusting a seat component comprises the step: vary the position of a pulling element using a seat-component adjusting device according to the invention in dependence upon an angle of rotation of the rotary element in order to adjust the seat component in dependence upon the angle of rotation of the rotary element. In said case, the angle of rotation of the rotary element is determined by the angle between any desired initial position of the rotary element and an instantaneous position of the rotary element. Through use of the seat-component adjusting device according to the invention, reliable adjustment of the seat component is made possible. In particular, the method according to the invention may be implemented also when the available installation space is small.

The pulling element is preferably a flexible pulling element, and the step, vary the position of the pulling element, is realized by winding or unwinding the flexible pulling element onto or from the rotary element in order to adjust the seat component in dependence upon the degree of take-up.

In the case of the method according to the invention, the seat component may be a headrest. The method according to the invention may then in particular include the steps, adjust a height of the headrest and/or adjust an inclination of the headrest, in each case in dependence upon the position of the pulling element and/or upon the degree of take-up of the flexible pulling element. Thus, by means of the method according to the invention a headrest may be adjusted in terms of its various degrees of freedom.

In the case of the method according to the invention, the seat component may also be a lumbar support. The method according to the invention may then in particular include the steps, adjust a height of the lumbar support and/or adjust a curvature of the lumbar support, in each case in dependence upon the position of the pulling element and/or upon the degree of take-up of the flexible pulling element. Thus, by means of the method according to the invention a lumbar support may be adjusted in terms of its various degrees of freedom.

The seat-component adjusting device according to the invention and the corresponding method may be used for many different seats. In particular, the seat-component adjusting device according to the invention and the corresponding method are used for vehicle seats, wherein the compact overall size of the seat-component adjusting device according to the invention enables easy accommodation thereof in or on the vehicle seat.

A seat according to the invention may be any type of seat that has an adjustable seat component, in particular a vehicle seat or an item of office furniture. The expected field of application of the invention is correspondingly wide.

There now follows a detailed description of preferred embodiments with reference to the drawings.

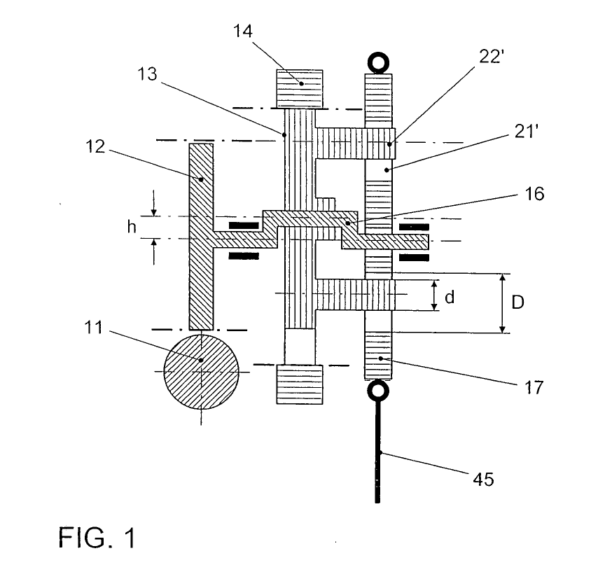

FIG. 1 is a diagrammatic cross-sectional view of a first embodiment of a seat-component adjusting device according to the invention.

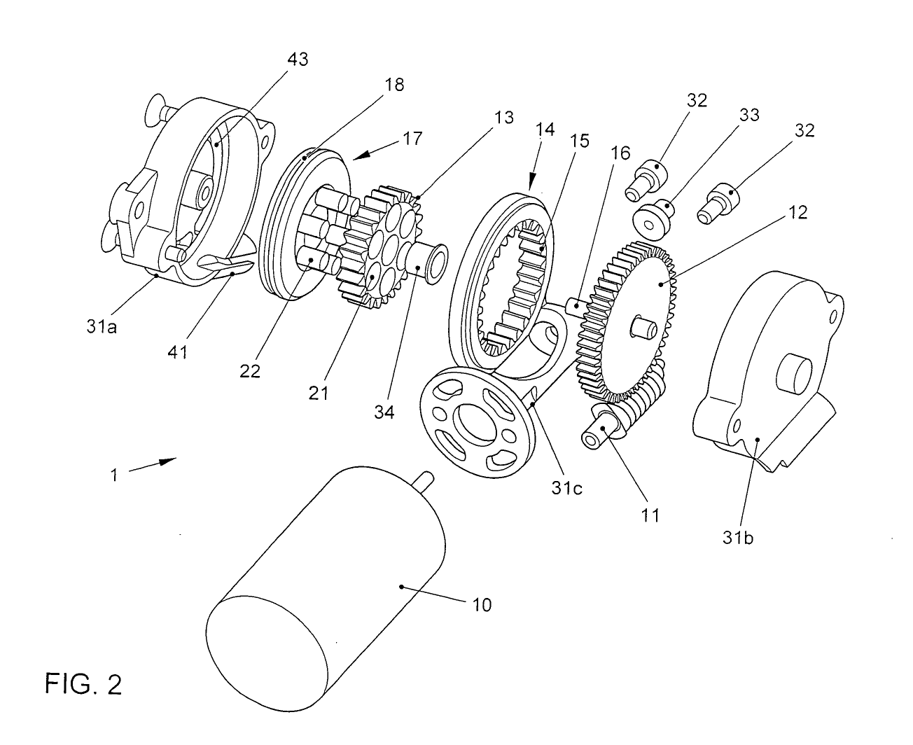

FIG. 2 is a perspective exploded view of a second embodiment of a seat-component adjusting device according to the invention.

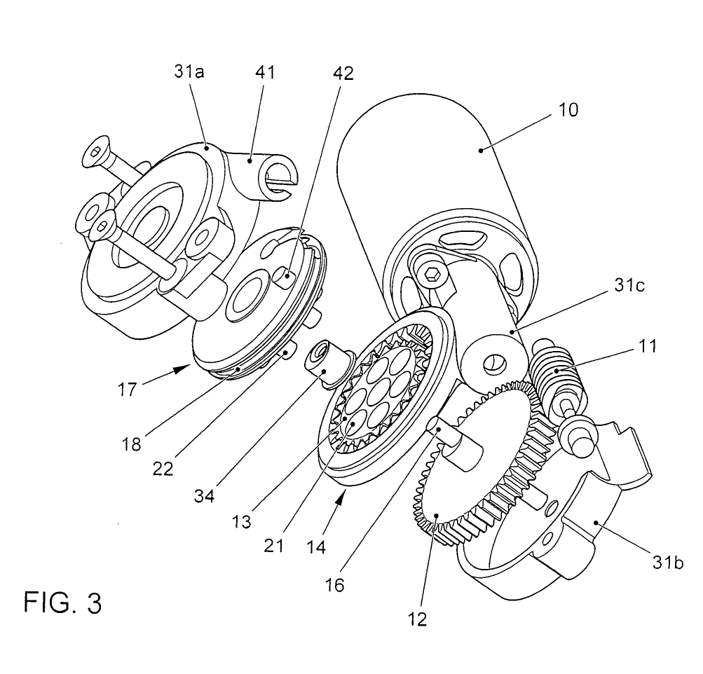

FIG. 3 is a perspective exploded view of the seat-component adjusting device illustrated in FIG. 2 from a different viewing angle.

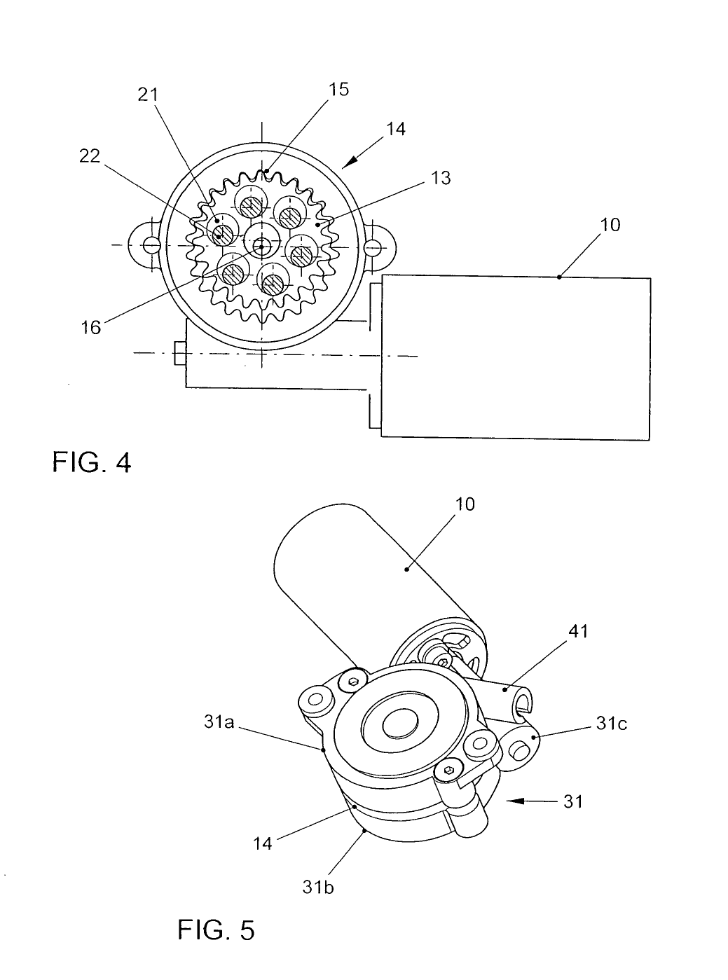

FIG. 4 is a cross-sectional view of the seat-component adjusting device illustrated in FIG. 2.

FIG. 5 is a perspective view of the seat-component adjusting device illustrated in FIG. 2 in an assembled state.

First, the construction and operation of a first embodiment of a seat-component adjusting device according to the invention are described with reference to FIG. 1. The seat-component adjusting device comprises a combination of a worm gear and an eccentric gear, which are coupled to one another, wherein the eccentric gear is likewise coupled to a rotatably supported cable pulley or roller 17.

The worm gear comprises a worm 11 and a worm wheel 12, and the eccentric gear comprises a ring gear 14 with internal gearing as well as a rotor 13 with external gearing, wherein the rotor 13 is in mesh with the ring gear 14. The worm 11 is driven by an electric motor (not shown in FIG. 1). Provided on the worm wheel 12 is an eccentric 16, which describes a circular movement with a radius h when the worm gear is driven by the electric motor. The radius h is selected to be equal to the difference of the geometrical radius of the internal gearing of the ring gear 14 and the geometrical radius of the external gearing of the rotor 13, h=(z₄−z₃)×m/s, in which m is the modulus of the internal gearing of the ring gear 14 and/or of the external gearing of the rotor 13. A portion of the eccentric 16 is disposed in a central recess of the rotor 13. When the eccentric 16 executes its circular movement, the rotor 13 is rolled internally on the ring gear 14. In said case, the rotor 13 executes a wobbling movement, whereby it rotates about its axis and at the same time moves along an inner periphery of the ring gear 14.

The transmission ratio |_{S} of the worm gear step is determined by the tooth number z₁ of the worm and the tooth number z₂ of the worm wheel and represented by |_{S}=z₂/z₁. The transmission ratio |_{E} of the eccentric gear is determined by the tooth number z₃ of the rotor and the tooth number z₄ of the ring gear and represented by |_{E}=z₃/(z₄−z₃). The total transmission ratio |_{G} of the combination of worm gear and eccentric gear is represented by |_{G}=|_{S}×|_{E}. In advantageous embodiments, 1≦z₁≦3, 15≦z₂≦25, 20≦z₃≦40, while z₄−z₃=2. In an advantageous embodiment with z₁=1, z₂=15, z₃=24 and z₄=26, therefore, |_{S}=15 and |_{E}=12. In alternative embodiments, 1≦z₄−z₃≦3. By virtue of this combination of the worm gear step and the eccentric gear step, high transmission ratios may be achieved. The eccentric gear step, which transmits high forces, also has a high engagement factor.

In order to convert the wobbling movement of the rotor 13 into a purely rotational movement of the cable pulley 17, the seat-component adjusting device comprises coupling means, which in the embodiment of FIG. 1 comprise a plurality of pins 22′ provided on the rotor 13 and an equal number of recesses 21′ provided on the cable pulley 17, wherein at least one portion of each pin 22′ is disposed inside the corresponding recess 21′. The pins 22′ and the recesses 21′ have a cylindrical outer periphery. In said case, the radius D of each recess 22′ is greater by the difference of the pitch diameters of the ring gear and the rotor than the radius d of each pin 21′, D=d+2×h. When the rotor 13 executes a wobbling movement, the pins 21′ move along the edge of the corresponding recesses 22′ in such a way that the edge of each pin 21′ touches the edge of the corresponding recess 22′. The wobbling movement of the rotor 13 is therefore transformed into a purely rotational movement of the cable pulley 17. The ratio of the angular velocities of the worm gear 12 and the cable pulley 17 is equal to the transmission ratio |_{E} of the eccentric gear step. If the worm 11 is driven at a constant speed of rotation by the electric motor, then in particular the cable pulley 17 also rotates at a constant angular velocity about its axis.

One end of a flexible pulling element 45 is coupled to the cable pulley. The flexible pulling element 45 is designed for coupling to an adjustable seat component, e.g. a headrest or lumbar support. The flexible pulling element 45 may in particular be a Bowden cable, wherein one end of the wire cable of the Bowden cable is fastened to the cable pulley 17. The cover or sheath of the Bowden cable is supported on the housing (not shown in FIG. 1) of the adjusting device. Upon rotation of the cable pulley 17, in dependence upon the direction of rotation thereof a portion of the wire cable of the Bowden cable is wound onto the cable pulley 17 or unwound from the cable pulley 17.

In the case of a seat that includes the seat-component adjusting device according to the invention, the flexible pulling element 45 is moreover coupled typically in the vicinity of the other end, which is not coupled to the cable pulley 17, to an adjustable seat component, e.g. a headrest or lumbar support. The adjustable seat component is designed to be adjusted in dependence upon the degree of take-up of the flexible pulling element 45 so that, when in use, the adjustment of the adjustable seat component is achieved by winding or unwinding the flexible pulling element 45 onto or from the cable pulley.

Whilst the coupling means, which are provided for transforming the wobbling movement of the rotor 13 into a rotational movement of the cable pulley 17, are realized in the present case by pins 22′ provided on the rotor 13 and by recesses 21′ provided on the cable pulley 17, numerous modifications of this design are possible, as is explained with reference to FIGS. 2-5 for a second embodiment of the seat-component adjusting device according to the invention. The second embodiment differs from the first in that a coupling of the rotor 13 to the cable pulley 17 is realized by means of recesses 21 provided on the rotor 13 and by means of pins 22 provided on the cable pulley 17. Apart from this modified design of the coupling means, the central components of the seat-component adjusting device, in particular the worm 11, the worm wheel 12, the rotor 13, the ring gear 14, the cable pulley 17 and the flexible pulling element 45, as well as their effect and mode of operation are identical to the first embodiment.

In addition to the recesses 21 for receiving the pins 22, the rotor 13 comprises a central recess, in which a bearing 34 for receiving at least one portion of the eccentric 16 provided on the worm wheel 12 is disposed. Upon rotation of the worm wheel 12, the rotor 13 is set by this arrangement into a wobbling movement, as described above. The wobbling movement of the rotor 13 is converted by the recesses 21 and pins 22 into a purely rotational movement of the cable pulley 17, as is likewise described above. The basic mode of operation of the coupling means formed by the recesses 21 and the pins 22 for coupling the rotor 13 to the cable pulley 17 is shown particularly clearly in the cross-sectional view of FIG. 4. As is evident from the perspective exploded views of FIGS. 2 and 3, the worm 11, the worm wheel 12, the rotor 13 and the cable pulley 17 are accommodated in a housing that comprises first to third housing portions 31a-31c. The electric motor 10 is fastened by screws 32 or any other desired fastening elements to the third housing portion 31c, wherein a bearing 33 is provided for the shaft of the electric motor. As is apparent from FIGS. 2, 3 and 5, the ring gear 14 is designed in such a way that an outer portion of the ring gear 14 acts as a portion of the housing 31. Furthermore, the ring gear is constructed integrally with the third housing portion 31c.

The cable pulley 17 is supported rotatably by means of the bearing 34 on the first housing portion 31a. As may best be seen from FIG. 2, the first housing portion has a recess in the form of a groove 43 in the shape of a graduated circle, with which a projection 42 provided on the cable pulley 17 is in engagement. The groove 43 and the projection 42 allow the definition of a limited angular range, through which the cable pulley 17 may rotate. By virtue of an appropriate design of the groove 43, in particular by altering its length, the angular range, through which the cable pulley 17 may rotate, may easily be set.

Provided along the periphery of the cable pulley 17 is a recess 18 that is designed, when in use, to receive the take-up portion of the flexible pulling element, e.g. the wire cable of a Bowden cable, that is coupled to the cable pulley 17. Integrally formed on the housing 31a is a portion 41 for securing the sheath of the Bowden cable. As already mentioned above, when the seat-component adjusting device is in use in a seat, typically one end of the Bowden cable is coupled to the seat-component adjusting device, the other end to an adjustable seat component. The adjustable seat component is designed to be adjusted in dependence upon a free length of the wire cable of the Bowden cable, i.e. in dependence upon the degree of take-up of the flexible pulling element. Thus, through actuation of the seat-component adjusting device the wire cable of the Bowden cable may be wound up or unwound and the adjustable seat component may be adjusted.

Typical examples of adjustable seat components are lumbar supports and headrests, such as are used in vehicle seats. In said case, the seat-component adjusting device according to the invention may be used for example to adjust a height or curvature of the lumbar support or to adjust a height or inclination of the headrest. However, the areas of application of the seat-component adjusting device are not restricted thereto but include seats with any desired adjustable components.

Several modifications of the embodiments represented above are possible. Whereas, in the embodiments represented above, the recesses 21 and/or 21′ are provided either on the rotor 13 or on the cable pulley 17 and the pins 22 and/or 22′ are provided on the respective other element, it is for example also possible for a first number of pins and a second number of recesses to be provided on the rotor 13 and be in paired engagement with a first number of recesses and a second number of pins on the rotary disk.

In the second embodiment illustrated in FIGS. 2-5, the number of the pins 21 and the corresponding recesses 22 equals six. This number may however easily be varied. In an advantageous embodiment, the number of pins and corresponding recesses is in each case greater than or equal to four.

Furthermore, the diameter of all pins need not be identical and the diameter of all recesses need not be identical. Rather, the diameters may vary so long as for each pair comprising a pin and a corresponding recess the previously described relationship between the diameters of the pin and recess is maintained.

The design of the housing described with reference to FIGS. 2-5 may also easily be modified. Whereas in this embodiment the ring gear 14 is constructed integrally with the third housing portion 31c and designed in such a way that an outer portion of the ring gear forms a portion of the housing 31, the ring gear 14 may alternatively be provided separately from the housing and fitted inside the housing. The housing might also be composed of fewer than three portions. For example, the first and third housing portions 31a, 31c might also be of an integral design.

Whereas in the previous embodiments the pulling element was a flexible pulling element, in particular a Bowden cable, the pulling element may alternatively be a rigid body, in particular a gear rack. In the case of a gear rack, there is provided on the rotary element a gearing that is in mesh with the gearing of the gear rack. Upon rotation of the rotary element, the gear rack is displaced in a translatory manner, i.e. the position of the gear rack is varied. When in use, the gear rack may be coupled directly to the seat component that is to be adjusted. Alternatively, a wire pull may be fastened to the gear rack and to the seat component to be adjusted, in order to couple these.

As FIG. 5 reveals, the seat-component adjusting device according to the invention having an electric motor 10 and the worm gear, the eccentric gear and the cable pulley, which are accommodated in the housing 31, is of a compact overall size. By virtue of the combination of worm gear and eccentric gear, moreover, a high transmission ratio may be achieved.

1-21. (canceled)

22. An adjusting device for a seat component, the adjusting device comprising:
a rotary drive;
a worm gear driven by the rotary drive;
an eccentric gear driven by the worm gear;
a rotary member driven by the eccentric gear, the rotary member and the eccentric gear cooperating to define a coupling that converts movement of the eccentric gear into rotational movement of the rotary member, wherein rotational movement of the rotary member adjusts the seat component.

23. The adjusting device of claim 22, further comprising a pulling member coupled to and extending between the rotary member and the seat component, and wherein movement of the pulling member in response to rotational movement of the rotary member adjusts the seat component.

24. The adjusting device of claim 23, wherein the pulling member is an elongated flexible member.

25. The adjusting device of claim 24, wherein the pulling element is a Bowden cable.

26. The adjusting device of claim 22, wherein the coupling includes a first coupling element defined by one of the eccentric gear and the rotary member, and a second coupling element defined by the other of the eccentric gear and the rotary member.

27. The adjusting device of claim 26, wherein the first coupling element comprises a plurality of pins, and the second coupling element comprises a plurality of recesses, and wherein each of the plurality of pins is received by a corresponding one of the plurality of recesses.

28. The adjusting device of claim 27, wherein the worm gear comprises a worm coupled to the rotary drive and a worm wheel, and wherein the eccentric gear comprises a rotationally fixed ring gear including inner gear teeth, and a rotor received by the ring gear for eccentric movement therein and including outer gear teeth that engage the inner gear teeth of the ring gear.

29. The adjusting device of claim 28, further comprising an eccentric extending from the worm wheel and rotating therewith, and wherein the eccentric guides the rotor along the inner gear teeth of the ring gear.

30. The adjusting device of claim 28, wherein a diameter of each of the plurality of pins is smaller than a diameter of the corresponding one of the plurality of recesses by an amount substantially equal to a difference between a pitch diameter of the ring gear and a pitch diameter of the rotor.

31. The adjusting device of claim 28, wherein the worm, the worm wheel, the rotor and the rotary member are disposed in a housing.

32. The adjusting device of claim 31, wherein a portion of the ring gear forms a portion of the housing.

33. The adjusting device of claim 31 further comprising a Bowden cable having a sheath, the Bowden cable coupled to and extending between the rotary member and the seat component, and the sheath coupled to a portion of the housing, wherein movement of the Bowden cable in response to rotational movement of the rotary member adjusts the seat component.

34. A seat comprising:
a frame;
a seat component adjustably coupled to the frame;
a rotary drive coupled to the frame;
a worm gear driven by the rotary drive;
an eccentric gear driven by the worm gear;
a rotary member driven by the eccentric gear, the rotary member and the eccentric gear cooperating to define a coupling that converts movement of the eccentric gear into rotational movement of the rotary member;
a pulling element coupled to and extending between the rotary member and the seat component, wherein rotation of the rotary member moves the pulling element to adjust the seat component.

35. The seat of claim 34, wherein the seat component is a lumbar support.

36. The seat of claim 34, wherein the adjustable seat component is a headrest.

37. A method of adjusting a seat component, the method comprising:
operating a rotary drive;
rotating a worm gear in response to operation of the rotary drive;
driving an eccentric gear eccentrically about a ring gear in response to rotation of the worm gear;
changing an angle of rotation about an axis of a rotary member by way of a coupling defined by the eccentric gear and the rotary member in response to driving of the eccentric gear; and
adjusting the seat component in response to changing the angle of rotation of the rotary member.

38. The method of claim 37 further comprising varying the position of a pulling element coupled to the seat component in response to changing the angle of rotation of the rotary member, including winding the pulling element about the rotary member.

39. The method of claim 38, wherein the seat component includes a headrest, and wherein adjusting the seat component includes varying the height of the headrest in response to varying the position of the pulling element.

40. The method of claim 38, wherein the seat component includes a lumbar support, and wherein adjusting the seat component includes varying a curvature of the lumbar support in response to varying the position of the pulling element.
